(19) United States
(12) Patent Application Publication
(10) Pub. No.: US 2002/0066018 A1
(43) Pub. Date: May 30, 2002

(54) Multiple autentication sessions for content protection

(76) Inventor: Johan Paul Marie Gerard Linnartz, Eindhoven (NL)

Correspondence Address: Corporate Patent Counsel, U.S. Philips Corporation, 580 White Plains Road, Tarrytown, NY, 10591, US

(21) Appl. No.: 09/982,260

(22) Filed: Oct. 17, 2001

(30) Foreign Application Priority Data
Oct. 18, 2000 (EP) 00203609.3

(51) Int. Cl. H04L 9/00

(52) U.S. Cl. 713/171; 380/270

(57) ABSTRACT

The invention is in the field of consumer devices. The term “consumer device” is used to indicate various electrical, electronic and mechanical devices, which can be used in the work place and in and around home.

The invention relates to a method for secure data communication between consumer devices. Methods in which the user of the devices chooses which device he trusts and which device must be authenticated are known. These methods are not suitable in the situation in which the user can not be trusted. The method according to the invention therefore comprises the following steps: a) activating a data communication link between the devices, b) transmitting data between the devices for performing an authentication session (3) for authenticating the consumer devices (1,2), wherein the authentication session (3) generates a first key (5), and c) transmitting data between the devices for performing another authentication session (4) for authenticating the consumer devices (1,2), wherein the authentication session (4) generates a second key (6).

The invention further relates to a consumer device and a signal.

### The invention relates to a method for secure data communication between consumer devices, the method comprising the following steps:

a) activating a data communication link between the devices,

b) transmitting data between the devices for performing an authentication session for authenticating the consumer devices, wherein the authentication session generates a first key.

The invention further relates to a consumer device and a signal.

The invention is in the field of consumer devices. The term “consumer device” is used to indicate various electrical, electronic and mechanical devices, which can be used in the work place and in and around home. Not limiting examples of these devices are optical disc players, TVs, VCRs, musical equipment, mobile telephones, domestic appliances (like microwave ovens), alarm devices and garage doors.

A method as mentioned above is disclosed in “Specification of the Bluetooth System”, v1.0B, Dec. 1, 1999, Specification Volume 1 (Core), Part B, Baseband Specification (More information on Bluetooth can be found on http://www.bluetooth.com). In this Specification the Bluetooth link encryption is standardized. This link encryption is based on a symmetric cryptographic algorithm. The cryptographic keys as used in this algorithm are derived from a consumer device ID and an authentication process. An authentication process is a process which is used by a consumer device to prove to another consumer device that it is actually the device it tells it is. The authentication process as performed in the Bluetooth link encryption is designed to provide user privacy when the user communicates between two of his two devices. This is achieved in the following way: the user chooses which device(s) he trust and brings ‘in close contact’ his user device and another consumer device. These two devices must share a common cryptographic secret. It is the user's responsibility that no eavesdropper can tap into the exchange of messages and modify the message content. Another authentication session is performed in the Bluetooth link encryption when the user chooses a PIN code in order to ensure that no unauthorized person can use his Bluetooth device(s). The PIN code is used here to authenticate the user.

However, if the system is used to exchange digital content for which the user has to pay, the user may be tempted to try and break the security. By changing the PIN number numerous times, a malicious user might be able to gain information on the security system and eventually be able to retrieve some or all the link keys and the encryption key. This means that the user is able to intercept and decrypt encrypted content or authenticate non-compliant devices.

It is clear that when using the Bluetooth link encryption the user of the devices chooses which device he trusts. This link encryption is therefore not suitable in the situation in which the user is not trusted and can not be asked to play the role of trusted authority. This is, for example, relevant in the case where it must be prohibited that the user can attach to the device and copy or get access to content, stored on this device, illegally.

The invention has for its object to provide a method for secure data communication between consumer devices, in which the user of the devices can not be trusted.

In other to achieve this object, the method in accordance with the invention is characterized in that the method further comprises the step of:

c) transmitting data between the devices for performing another authentication session for authenticating the consumer devices, wherein the authentication session generates a second key.

The invention is based on the recognition that the security requirements for suitable content protection measures differ essentially from the security requirements for suitable user privacy protection measures, as for example implemented in the Bluetooth link encryption. As stated above, this kind of link encryption is not suited for content protection as the user is not trusted and can not be asked to play the role of trusted authority. Content protection is, for instance, used when data is digitally transferred from a sending device to a receiving device to ensure that only an authorized receiving device is able to process or render the content.

The (first) authentication session is performed for authenticating consumer devices, e.g. in order to enable user privacy, while the other (second) authentication session is performed for authenticating consumer devices, e.g. in order to enable content protection. For example, when a user wants to download music from his PC to his portable MP3-player, in the first authentication session, the PC authenticates itself to the MP3-player as the particular PC, which comprises SDMI complaint MP3 content and the MP3-player authenticates itself to the PC as an MP3-player. In the second authentication session, the portable MP3-player authenticates itself to the PC as an MP3 -player which is allowed to receive the SDMI complaint MP3 content and the PC authenticates itself to the MP3 -player.

The invention has as an additional advantage that the method according to the invention can be introduced while maintaining functionality if older consumer devices are used. This is for example important if the link encryption according to the Bluetooth specification is used, as, within the Bluetooth consortium, interoperability is regarded as an essential feature. Moreover if provides interoperability between compliant and non-compliant consumer devices. Compliant consumer devices are devices that can proof to each other that they know a secret that is only made available to devices which, have been certified to adhere to predefined content and/or copy protection rules.

Another method according to the invention is characterized in that the method further comprises the step of: d) generating a link key for encrypting and/or decrypting the data communicated over the data communication link by merging the first key with the second key using a key merge function. Adding this step to the method has the advantage that the information to be transmitted between the consumer devices is better protected against eavesdroppers.

Another method according to the invention is characterized in that the authentication sessions are performed independent of each other. Another method according to the invention is characterized in that step b) further comprises transmitting additional data between the devices for deciding whether of not to proceed with step c). Depending on the status of the different consumer devices that are used in the method, one or two authentication sessions must be performed. It is therefore advantageous to transmitting additional data between the devices for deciding whether of not to proceed with the second authentication session and also to perform both authentication sessions independent of each other, in other to be able to perform only one session.

Another method according to the invention is characterized in that the key merge function is a bit-wise XOR-function.

Another method according to the invention is characterized in that the key merge function comprises encrypting the first key with the second key or vice versa. This results in a more robust system for authentication against a malicious user.

The invention also relates to a consumer device for performing the method according to the invention, the consumer device comprising means for activating a data communication link, means for transmitting data, authentication means for performing an authentication session and further authentication means for performing another authentication session.

Another consumer device according to the invention is characterized in that the consumer device further comprises an Application Programmers Interface (API) for informing the consumer device about the protection status of another consumer device.

Another consumer device according to the invention is characterized in that the consumer device further comprises receiving means for receiving information, decrypting means for decrypting the information using the link key and recording means for recording the information.

The invention also relates to a signal, for example to a signal comprising data as used in the authentication sessions for authenticating the devices, a signal comprising a first key and a second key obtained after performing the method according to the invention or a signal further comprising a link key for encrypting and/or decrypting the data communicated over the data communication link, the link key being generated by merging the first key with the second key using a key merge function.

These and other aspects of the invention will be further described in the figure description, in which

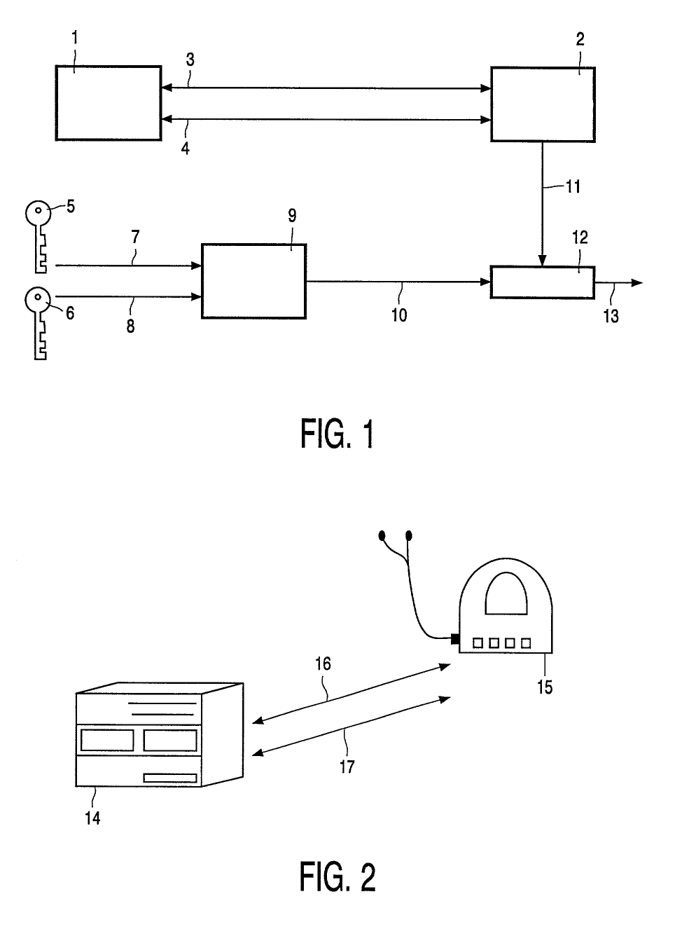

FIG. 1 shows a schematic overview of the method for secure data communication according to the invention,

FIG. 2 shows a first practical implementation of the method according to the invention, comprising a music installation and a portable CD-player,

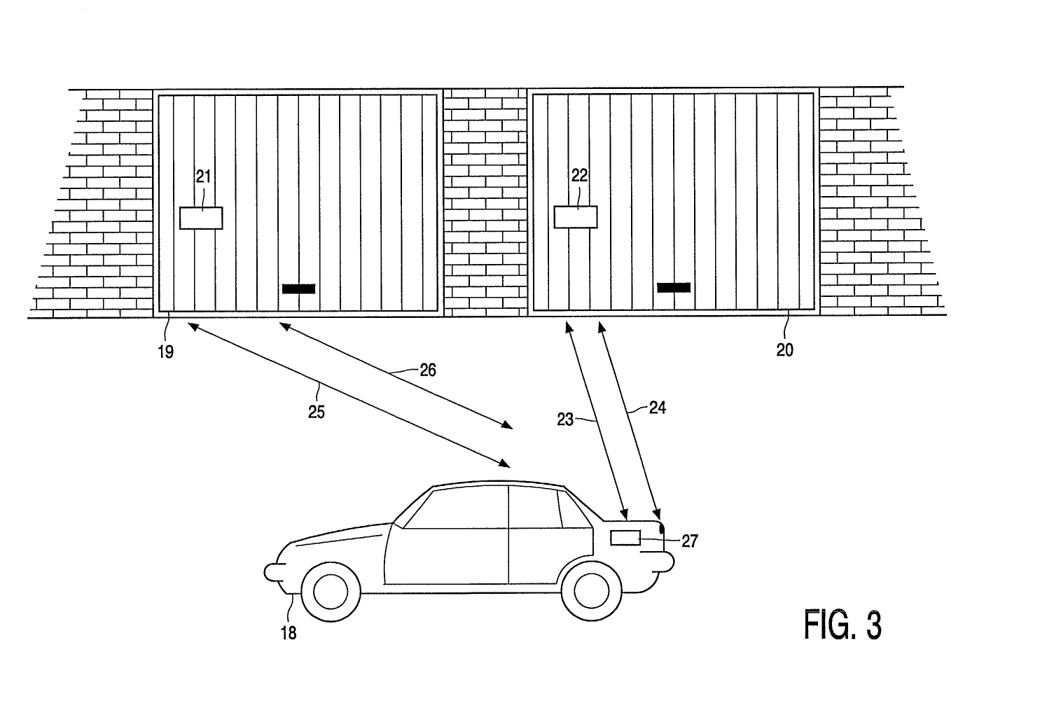

FIG. 3 shows a second practical implementation of the method according to the invention, comprising a car and a garage door.

In FIG. 1 a schematic overview of the method for secure data communication according to the invention is shown. A possible implementation of the method according to the invention can be found in European Patent Application Filing No. 00203592.1 (PH-BE000019), 18.10.2000).

After activating a data communication link between consumer devices 1 and 2 (not shown), two independent authentication sessions 3 and 4, each comprising key generation, are performed between the consumer devices 1 and 2. The first authentication session 3 serves the purpose of protecting the users privacy, and is identical to the key set up already used in Bluetooth.

This Bluetooth technology provides peer-to-peer communication over a relatively short distance of approximately ten meters. The system provides security measures both at the application layer and at the link layer. The link layer security measures are described in Chapter 14 of the Baseband Specification as mentioned before. This chapter describes the way in which authentication takes place between Bluetooth devices and the generation of keys that can be used for encryption/decryption purposes. Four different entities are used for maintaining security at the link layer: a public address which is unique for each user (the 48-bit IEEE Bluetooth device address, BD_ADDR), a private user key for authentication, a private user key for encryption and a random number (RAND) of 128 bits. The encryption key can be used for content protection. The random number is different for each new transaction. The private keys are derived during initialization and are further never disclosed. Normally, the encryption key is derived from the authentication key during the authentication process. For the authentication algorithm, the size of the key used is always 128 bits. For the encryption algorithm, the key size may vary between 1 and 16 octets (8-128 bits). The size of the encryption key is configurable, among others to meet the many different requirements imposed on cryptographic algorithms in different countries—both with respect to export regulations and authority attitudes towards privacy in general. The encryption key is entirely different from the authentication key (even though the latter is used when creating the former). Each time encryption is activated a new encryption key shall be generated. Thus, the lifetime of the encryption key does not necessarily correspond to the lifetime of the authentication key. It is anticipated that the authentication key will be more static to its nature than the encryption key—once established the particular application running on the Bluetooth device decides when, or if, to change it. To underline the fundamental importance of the authentication key to a specific Bluetooth link, it will often be referred to as link key. The RAND is a random number that can be derived from a random or pseudo-random process in the Bluetooth unit. This is not a static parameter, it will change frequently. It is in the interest of a user to ensure that no unauthorized person can use his Bluetooth device(s). For this reason, the user may choose a PIN code. As such, a user may be expected to use the Bluetooth system as intended for purposes which, for instance, involve privacy.

For reasons of national security or exportability, this first session is upperbounded to a limited number of key bits, in cryptographic sense, that are generated. The second authentication session 4 serves the purpose of content protection, by identifying the consumer device as being compliant and determining its functionality (e.g. rendering device, recorder). The result of the first authentication session 3, the key 5, is merged with the result of the second authentication session 4, the key 6, in the key merge 9. This merging is performed using a key merge function, e.g. an XOR-function. Instead of an XOR-function, also other key merge solutions can be chosen, like encrypting the first key 5 with the second key 6 (in which one of the keys is the PIN code which must be provided by the user; this results in a more robust system for authentication against malicious users, in which devices can proof to each other that they are certified as being compliant and an additional level of robustness, tunable via the choice of the key merging function, to the privacy protection). The result of this key merge is a link key which is communicated over communication line 10. This link key is used in module 12 for encryption and/or decrypting the information stored in consumer device 2, supplied over communication line 11. The encrypted or decrypted information is communicated over communication line 13. This information can be supplied to the authenticated consumer device 1. The link key is used in both consumer devices, for encrypting the content before transmission in one device, and for decrypting the content after receipt in the other device.

The method as shown here by way of example has the following properties:

It allows the user to select trusted devices which he wants to be able to communicate with, for example for providing privacy protection. In this phase the user is trusted and he is in control of the outcome of authentication and key generation. With reference to FIG. 1, the user can, for example, select consumer device 1 as the trusted device.

It includes a mechanism for authentication in which devices can proof to each other that they are certified as being compliant. This phase must be fully robust against malicious users. With reference to FIG. 1, the user can, after selecting consumer device 1 as the trusted device, “ask” consumer device 2 to authenticate himself as being compliant.

It allows key escrow of private communications in countries where this a legal requirement. In those countries, the master secrets are made available to a national security agency in order to enable it to derive the key 6, as created by performing the second authentication session. A key escrow system is an encryption system with a backup decryption capability that enable authorized authorities (e.g. a national security agency) to recover strong encryption key where this is a legal requirement.

It enables interoperability between compliant and non-compliant consumer devices to the fullest extent possible, within the limitations of the rights of the user. This will be explained below in detail.

It allows key revocation. It is left to the particular application to decide on whether or not to release content at high quality. This decision may depend on whether first authenticated consumer device itself to be compliance. Also a revocation mechanism can be checked before content is released.

In another embodiment of the consumer system for the method according the invention, the communication system further comprises an Application Programmers Interface (API) for informing a consumer device of the system about the protection status of another consumer device of the system. This API allows an application as used in a consumer device to find out what effective key length is used on the authentication session link and whether the other consumer device is compliant, and what type of functionality that consumer device has. The API does not allow the application to control or influence the key generation algorithm.

When performing the method according to the invention the following different situations can occur. They will be elaborated with reference to the method as explained with reference to FIG. 1.

Compliant content source and non-compliant playing device: In this situation, the second authentication session 4 results in the all zero word. By this result, the “trusted” device knows that the other consumer device is non-compliant. Protected content can be exchanged at a quality level accepted by the rights owners (e.g. CD quality or below, stereo only, etc).

Compliant content source and non-compliant recorder device: In this situation, no restrictions on recording “Copy Free” content are imposed on the non-compliant recorder device. It can be chosen that “Copy Once” content is only delivered to this consumer device of a limited quality and that “Copy Never” content will not be delivered.

Non-compliant content source and compliant receiving device: In this situation, no restrictions on the use of the content are imposed by the source. In the receiving device, the content must be handled as if it came from an analog or unprotected digital input.

Compliant content source with SDMI content and compliant receiving device:

According to the recent SDMI Specification, SDMI content is allowed to be sent over links that are protected. As the Bluetooth specification defines a secure link encryption system, Bluetooth can be used to send SDMI content. High quality content can be used if the consumer devices is used are compliant, limited quality content can be used if at least one of the consumer devices is non-compliant.

In FIG. 2 a first practical implementation of the method according to the invention is shown. In this example the method is used in a communication system comprising a music installation 14 and a portable CD-player 15 and the user of the portable CD-player wishes to download some content stored in the music installation. After activating a data communication link between the devices, for example by using Bluetooth link encryption, a first authentication session 16 is performed between these two consumer devices. In this authentication session the music installation proves to the user of the portable CD-player that it is the consumer device the user wishes to download music from and the portable CD-player authenticates itself to the music installation as a portable CD-player. Next, a second authentication session 17 is performed between these two consumer devices. In this authentication session the portable CD-player proves to the music installation that the portable CD-player is allowed to download the content, i.e. it must prove it is compliant and the music installation authenticates itself to the portable CD-player. If both authentication sessions are successful, the key-merge block used for decrypting the encrypted content from the music installation is generated and the music can be downloaded to the portable CD-player.

In FIG. 3 a second practical implementation of the method according to the invention is shown. In this example the method is used in a garage door opening system. The elements of this system are a transmitter/receiver 27, being installed in a car 18 and transmitter/receivers 21 and 22, being installed in garage doors 19 and 20 respectively. In the event that the driver of the car 18 approaches his own garage door, in this case garage door 20, he first must prove that he drives the car belonging to this garage door 22, and not for example to the garage door of his neighbor, garage door 19. To this end, he performs a first authentication session 23 (with reference number 25, this same authentication session is depicted, in order to indicate that the information signals outputted by the transmitter/receiver 27 are also detected by the transmitter/receiver 21 of the garage door 19). Next, a second authentication session 24 is performed. In this authentication session the garage door 20 proves to the car 18 that it is the correct garage door and the car authenticates itself to the garage door. If this authentication is not performed, also garage door 19 might be opened, by performing the authentication session as indicated with reference number 26. If both authentication sessions are successful the garage door 20 is opened.

Whilst the invention has been described with reference to preferred embodiments therefor, it is to be understood that these are not limitative examples. Thus, various modifications may become apparent to those skilled in the art, without departing from the scope of the invention, as defined by the claims.

It must be noted that, although the embodiments are directed to use in the Bluetooth specification, the invention is not limited to the Bluetooth link encryption. Also the DECT security standard can be used in the method for secure data communication according to the invention. The invention is also not limited to wireless data communication, but can also be used in non-wireless ways of data communication, for example the Internet.

Further, the invention lies in all signals which can be used in performing the methods according to the invention or in the devices according to the invention. The invention also lies in all signals which are obtained when performing the methods according to the invention or when using the devices according to the invention. The invention also lies in each and every novel feature or combination of features.

1. Method for secure data communication between consumer devices, the method comprising the following steps:
a) activating a data communication link between the devices,
b) transmitting data between the devices for performing an authentication session (3) for authenticating the consumer devices (1,2), wherein the authentication session (3) generates a first key (5), characterized in that the method further comprises the step of:
c) transmitting data between the devices for performing another authentication session (4) for authenticating the consumer devices (1,2), wherein the authentication session (4) generates a second key (6).

2. The method as claimed in claim 1, characterized in that the method further comprises the step of:
d) generating a link key (9) for encrypting and/or decrypting the data communicated over the data communication link by merging the first key (5) with the second key (6) using a key merge function.

3. The method as claimed in claim 1 or 2, characterized in that the authentication sessions are performed independent of each other.

4. The method as claimed in claim 1, characterized in that step b) further comprises transmitting additional data between the devices for deciding whether of not to proceed with step c).

5. The method as claimed in claim 1, characterized in that the first authentication session is an authentication session as described in the Bluetooth link encryption specification.

6. The method as claimed in claim 2, characterized in that the key merge function has one or more of the following properties:
for any two given first and second keys as input in the key merge function, the link key output of the key merge function is uniquely specified;
the number of link key output bits is constant;—if the second key is undefined or all zero, the link key output bits are identical to the bits of the first key;
for any first key, the uncertainty in the output is approximately equal to the uncertainty of the second key;
for any second key, the uncertainty in the output is approximately equal to the uncertainty of the first key.

7. The method as claimed in claim 6, characterized in that the key merge function is a bit-wise XOR-function.

8. The method as claimed in claim 2, characterized in that the key merge function comprises encrypting the first key with the second key or vice versa.

9. Consumer device for performing the method according to one of the claims 1 to 8, the consumer device comprising means for activating a data communication link, means for transmitting data, authentication means for performing an authentication session and further authentication means for performing another authentication session.

10. The consumer device as claimed in claim 9, characterized in that the consumer device further comprises an Application Programmers Interface (API) for informing the consumer device about the protection status of another consumer device.

11. The consumer device as claimed in claim 9 or 10, characterized in that the consumer device further comprises receiving means for receiving information, decrypting means for decrypting the information using the link key (9) and recording means for recording the information.

12. The consumer device as claimed in claim 9, wherein the consumer device is a portable device, e.g. a headphone or a walkman.

13. The consumer device as claimed in claim 9, wherein the consumer device comprises means for performing short-range wireless data communication.

14. Signal comprising data transmitted between the devices (1,2) as used in any one of the methods 1 to 9, wherein the data is used for performing the authentication sessions (3,4) for authenticating the devices.

15. Signal comprising a first key (5) and a second key (6) obtained after performing the method of any one of the methods 1 to 9.

16. Signal according to claim 15, characterized in that it further comprises a link key (9) for encrypting and/or decrypting the data communicated over the data communication link, the link key being generated by merging the first key (5) with the second key (6) using a key merge function.
